(19) United States
(12) Patent Application Publication
(10) Pub. No.: US 2022/0145530 A1
(43) Pub. Date: May 12, 2022

(54) METHOD FOR DYEING MOULDED PARTS MADE FROM A POLYMER

(71) Applicant: DyeMansion GmbH, Planegg (DE)

(72) Inventor: Alena FOLGER, Kottgeisering (DE)

(21) Appl. No.: 17/581,549

(22) Filed: Jan. 21, 2022

Related U.S. Application Data
(63) Continuation of application No. PCT/EP2020/071007, filed on Jul. 24, 2020.

(30) Foreign Application Priority Data
Jul. 24, 2019 (DE) 10 2019 120 068.7

(51) Int. Cl. D06P 3/24; B33Y 40/20; D06P 5/04; D06P 3/34; D06P 3/79

(52) U.S. Cl. CPC D06P 3/241; B33Y 40/20; D06P 3/794; D06P 3/341; D06P 5/04

(57) ABSTRACT

A method is provided for dyeing a molded part produced in a 3D printing process with a polymer. The method includes a dyeing step for dyeing the surface of the molded part with a dye, and a first post-treatment step for fixing the dye which has penetrated the surface of the molded part. Optionally, a second post-treatment step can be carried out in order to achieve even better fixing of the dye which has penetrated the surface of the molded part.

### CROSS REFERENCE TO RELATED APPLICATIONS

This application is a continuation under 35 U.S.C. § 120 of International Application PCT/EP2020/071007, filed Jul. 24, 2020, which claims priority to German Application No. 10 2019 120 068.7, filed Jul. 24, 2019, the contents of each of which are incorporated by reference herein.

### FIELD OF THE INVENTION

The invention relates to a method for dyeing molded parts made from a polymer. In particular, the invention relates to a method for dyeing molded parts made from a polymer that are produced or have been produced in a 3D printing process.

### BACKGROUND

It is known to produce molded parts made from a polymer or from a flexible/elastic polymer in a light-curing 3D printing process.

3D-printed molded parts made from a polymer (also from a colored polymer) have a glossy surface, which can make the molded part look to be of low quality. Matt surfaces, on the other hand, would make a molded part look to be of higher or high quality.

Furthermore, the starting materials for the printing process are only available in a limited number of colors, which considerably limits the possibilities for 3D printing molded parts in different colors. It is known to provide a colored starting material (liquid resin or polymer powder) for 3D printing by adding dyes or color pigments to the starting material. Using the dyed starting material, a correspondingly dyed molded part can then be printed in the 3D printing process.

However, the dyes or color pigments added to the starting material change the processability of the starting material during the printing process, which is why the printing process requires complex adaptations for each color of the starting material. A particular problem here is that the added dyes and color pigments absorb some of the light energy and thereby seriously disrupt the printing process. The changing processibility of the starting material has to be compensated for by adapting the printing process in order to guarantee a reliable printing process that is the same for all colors. Extensive process optimization is required for this.

Particularly with dark colors, such as black, a very high amount of light energy is absorbed by the dyes or color pigments, and this makes the printing process uncontrollable, or even impossible, in many cases. This means that, particularly with dark to very dark colors of the material used, printing is not possible.

In addition, it is not readily possible to change from a starting material in one color to a starting material in a different color. This is because extensive cleaning of the installation space is necessary in order for it to be possible to eliminate any contamination of the starting material with the starting material previously used in a different color. Moreover, the resins are usually harmful or even poisonous in their non-polymerized state, which makes cleaning even more complex.

A problem addressed by the present disclosure is therefore that of providing a method for dyeing molded parts made from a polymer, in particular molded parts made from a polymer that are produced or have been produced in a 3D printing process, with which the aforementioned disadvantages are at least partially avoid-ed, and as a result of which the colors of the molded parts to be produced are not limited to the available colors of the starting material and a matt and thus high-quality-looking surface of the molded part is achieved.

### SUMMARY

According to this disclosure, this problem may be solved by a method for dyeing a molded part produced in a 3D printing process with a polymer in accordance with this disclosure.

Accordingly, this disclosure relates to a method for dyeing a molded part produced in a 3D printing process with a polymer, wherein the method comprises
a dyeing step (FS) for dyeing the surface of the molded part with a dye, and
a first post-treatment step (NBS1) for fixing the dye which has penetrated the surface of the molded part, wherein the first post-treatment step is carried out after the dyeing step,

wherein,

in the dyeing step,
the molded part is placed in a dye solution, wherein the dye solution comprises
a dye, preferably 0.0001 to 10 wt. %, particularly preferably 0.0001 to 1 wt. %, of a dye,
optionally an acid or an acid buffer, and
water, in particular proportions of water, preferably deionized water, to make up to 100 wt. %,

wherein the amount of the optional acid or acid buffer is selected such that the pH of the dye solution is between 2.5 and 7, and wherein the dye is introduced into the material of the surface of the molded part or penetrates the material of the surface of the molded part, and
the dye solution is heated, preferably to a temperature between 30° C. and 150° C., more preferably between 60° C. and 120° C., and, in the first post-treatment step,
the molded part dyed in the dyeing step is placed in a first fixing solution, as a result of which the dye which is introduced into the material of the surface of the molded part or penetrates the material of the surface of the molded part is fixed, wherein the first fixing solution comprises
   a polyphenol, an acrylic-based syntan compound, or a synthetic condensation product of aromatic compounds, such as phenols or naphthalenesulfonic acid, with formaldehyde or urea, preferably 0.0001 to 10 wt. %, particularly preferably 0.0001 to 0.5 wt. %, of a polyphenol, an acrylic-based syntan compound, or a synthetic condensation product of aromatic compounds, such as phenols or napthalenesulfonic acid, with formaldehyde or urea, and
water, in particular proportions of water, preferably deionized water, to make up to 100 wt. %, and
the first fixing solution is heated, preferably to a temperature between 30° C. and 150° C., more preferably between 60° C. and 90° C.

In addition to the dye, the water and the optional acid, the dye solution can also comprise further constituents. In addition, the first fixing solution can also comprise further constituents.

The 3D printing process is a light-curing 3D printing process, such as a photopolymerization process, in particular a bath-based photopolymerization process (vat photopolymerization), such as the SLA process (stereolithography), the DLP process (digital light processing), or the CDLP process (continuous digital light processing, including the CLIP process (continuous liquid interface production) from Carbon Inc.).

Other suitable 3D printing processes for producing molded parts made from a polymer can also be used.

The method according to embodiments of the invention accordingly comprises a dyeing step in which the surface of the molded part is dyed with a dye, with the dye penetrating the material of the surface, and a first post-treatment step in which the dye is additionally fixed.

During the dyeing process in the dyeing step, the dye is introduced into the material of the surface, i.e., the dye penetrates the surface of the molded part such that, after the dyeing step, the material on the surface is dyed to a certain penetration depth.

Due to the acid or acid buffer present in the dye solution, basic groups of the polymer can take up a proton. This promotes penetration of the water-soluble dye and the binding of the dye.

The method according to embodiments of the invention is also advantageous in that the color selection for the production of a colored molded part in 3D printing is not limited to the colors of the starting material (liquid resin). Instead, all the colors of metal complex dyes and acid dyes and combinations thereof are available for dyeing a 3D-printed molded part made from a polymer. Various metal complex dyes and/or various acid dyes can be mixed in order to obtain a broad spectrum of colors with which a 3D-printed molded part made from a polymer can be dyed according to embodiments of the invention. The dyeing method according to embodiments of the invention is also characterized in that it can also be carried out for small batch quantities or individual pieces of a certain color, while the direct dyeing of the resin, i.e., the starting material for printing, can only be carried out for larger quantities.

The post-treatment step advantageously reduces the mobility of the dye in the molded part to such an extent that the dye is prevented from migrating to other materials that come into contact with the molded part dyed according to embodiments of the invention. For it has been found that, between the polyphenols, the acrylic-based syntan compound, or the synthetic condensation products of aromatic compounds, such as phenols or naphthalenesulfonic acid, with formaldehyde or urea of the fixing solution and the dye which has penetrated the material of the surface of the molded part, larger complexes are formed that prevent migration of the dye through steric hindrance.

The method according to embodiments of the invention is suitable for dyeing a molded part made from the following polymers that has been produced in a 3D printing process
preferably polymers having a Shore hardness of 10 Shore A to 85 Shore D,
more preferably flexible/elastic polymers having a modulus of elasticity below 3000 MPa and a Shore hardness of 10 Shore A to 85 Shore D,
even more preferably flexible/elastic polymers based on olefin, acrylate and/or urethane.

Examples (commercial products) of these polymers are
EPU-41 from Carbon Inc. (elastomeric polyurethane)
FPU50 from Carbon Inc. (flexible polyurethane)
AdSint® TPU 80 from BASF 3D Printing Solutions GmbH (ester-based thermoplastic polyurethane),
Ultrasint TPU01 from BASF 3D Printing Solutions GmbH (ester-based thermoplastic polyurethane),
Luvosint TPU 92 from Lehmann & Voss & Co. KG (ester-based thermoplastic polyurethane),
Luvosint TPU 97 from Lehmann & Voss & Co. KG (ester-based thermoplastic polyurethane),
ESTANE® 3D TPU M95A from Lubrizol (ester-based thermoplastic polyurethane)
Elastic Resin from Formlabs Inc,
Ultrasint PP from BASF 3D Printing Solutions GmbH (polypropylene).

These polymers can optionally be enriched with a filler material, for example glass particles, carbon fibers, pigments, fillers or flow agents. This means that the material properties can be altered significantly where necessary. Plastics materials which have been filled or enriched in this way are considered to be plastics materials with which the molded part is produced in the 3D printing process, provided that the properties of the pure plastics material (i.e., the plastics material when not enriched with the filler materials) allow a molded part that can be dyed according to embodiments of the invention to be produced in a 3D printing process.

Another advantage of the method according to embodiments of the invention is that matt surfaces with a particularly high-quality appearance can be produced.

It is advantageous for the dye solution to additionally have a quaternary ammonium salt in a ratio to the dye of between 10:1 and 1:10 (mass ratio of quaternary ammonium salt to dye).

By using the quaternary ammonium salt in the dye solution, the dyeing time can be reduced without having to accept losses in terms of dye quality, the homogeneity of the dyeing and the migration of the dye.

The first fixing solution can additionally have an acid or an acid buffer, wherein the amount of acid or acid buffer is selected such that the pH of the first fixing solution is between 3 and 7.

It is advantageous for the dye solution to be heated after the molded part has been placed in the dye solution, wherein the dye solution is heated at a heating rate of below 5° C./min.

It is also advantageous for the first fixing solution to be heated after the dyed molded part has been placed in the first fixing solution, wherein the first fixing solution is heated at a heating rate of below 5° C./min.

The mentioned heating rates of below 5° C./min reduce the thermal stress to which the molded part is exposed and therefore ensure that the material properties are not changed too much in the dyeing or post-treatment step, for example effects such as thermal distortion are reduced to a minimum.

It is advantageous for the dye solution to be cooled to a temperature between 20° C. and 75° C. before the molded part is removed from the dye solution, wherein the cooling takes place at a cooling rate of below 5° C./min.

It is also advantageous for the first fixing solution to be cooled to a temperature between 20° C. and 75° C. before the molded part is removed from the first fixing solution, wherein the cooling takes place at a cooling rate of below 5° C./min.

The mentioned cooling rates of below 5° C./min reduce the thermal stress to which the molded part is exposed and therefore ensure that the material properties are not changed too much after the dyeing or post-treatment step, for example effects such as thermal distortion are reduced to a minimum.

The method can comprise an optional second post-treatment step for further fixing the applied dye, i.e., the dye which has penetrated the material of the molded part, wherein the second post-treatment step is carried out after the first post-treatment step, wherein, in the second post-treatment step,
the molded part is placed in a second fixing solution, wherein the second fixing solution comprises
   a salt of a trivalent or tetravalent cation, preferably 0.0001 to 10 wt. %, particularly preferably 0.0001 to 0.5 wt. %, of a salt of a trivalent or tetravalent cation, and
   water, in particular proportions of water, particularly preferably deionized water, to make up to 100 wt. %, and
the second fixing solution is heated, preferably to a temperature between 30° C. and 150° C., more preferably between 60° C. and 90° C.

The second fixing solution can comprise further constituents.

The second post-treatment step can optionally be carried out. The mobility of the dye in the molded part can advantageously be reduced even further by the second post-treatment step.

It is advantageous for the second fixing solution to be heated after the molded part has been placed in the second fixing solution, wherein the second fixing solution is heated at a heating rate of below 5° C./min.

The heating rates of below 5° C./min reduce the thermal stress to which the molded part is exposed in the second post-treatment step and therefore ensure that the material properties are not changed too much in the dyeing or post-treatment step, for example effects such as thermal distortion are reduced to a minimum.

It is advantageous for the second fixing solution to be cooled to a temperature between 20° C. and 75° C. before the molded part is removed from the second fixing solution, wherein the cooling takes place at a cooling rate of below 5° C./min.

The cooling rates of below 5° C./min before the molded part is removed from the second fixing solution reduce the thermal stress to which the molded part is exposed and therefore ensure that the material properties are not changed too much after the dyeing or post-treatment step, for example effects such as thermal distortion are reduced to a minimum.

It can also be advantageous for
the first fixing solution to be heated to a temperature between 30° C. and 45° C. before the molded part is placed in the first fixing solution, or
a concentrate of the fixing solution to be heated to a temperature between 30° C. and 45° C. and the heated concentrate to be mixed with water to obtain the fixing solution, wherein
   the molded part is placed in the water before the heated concentrate is mixed with the water, wherein the water is preferably likewise heated to a temperature between 30° C. and 45° C. before the heated concentrate is mixed with the water, or
   the molded part is placed in the fixing solution after the heated concentrate has been mixed with the water.

The dye solution can also comprise
ammonium or alkali salts as adjusters for dyes, and/or
a solubilizer, and/or
a leveling agent,
a defoamer, and/or
a solvent.

It is advantageous for the molded part to be cleaned
between the dyeing step and the first post-treatment step, and/or
between the first post-treatment step and the second post-treatment step preferably with water, particularly preferably with deionized water.

Chemical cleaning (e.g., by reductive cleaning) of the dyed component prior to the fixing step (i.e., prior to the first or second post-treatment step) is not required according to embodiments of the invention, however. Cleaning with water only ensures that no residues of the dye and/or the first fixing solution adhere to the molded part before it is put into a new solution.

It is advantageous for
the molded part to be placed in the dye solution for a period of between 5 minutes and 500 minutes, and/or
the molded part to be placed in the first fixing solution for between 5 minutes and 500 minutes, preferably between 10 minutes and 60 minutes.

Furthermore, it can be advantageous for the molded part to be placed in the second fixing solution for between 5 minutes and 500 minutes, preferably between 10 minutes and 60 minutes.

In addition, it can be advantageous for the dye to be selected from the group comprising metal complex dyes, acid dyes, reactive dyes, azo dyes, dispersion dyes, and mixtures thereof.

The polymer can be a polymer having a Shore hardness of 10 Shore A to 85 Shore D, preferably a flexible/elastic polymer having a Shore hardness of 10 Shore A to 85 Shore D, particularly preferably a flexible/elastic polymer based on acrylate and/or urethane.

### BRIEF DESCRIPTION OF THE DRAWING

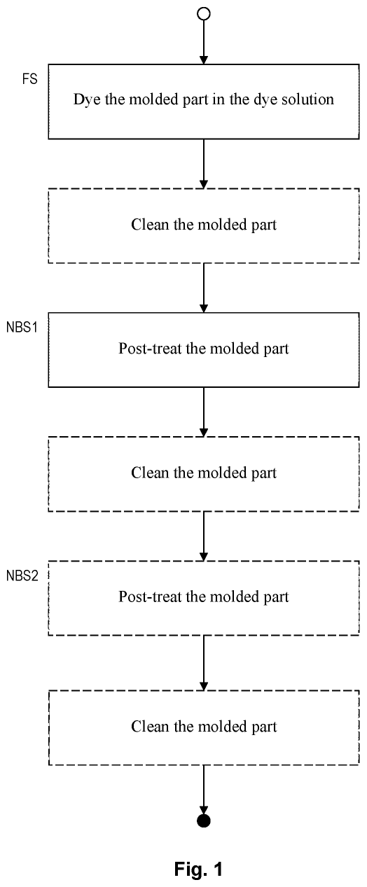

Further details and features of the invention will become apparent from the following description taken in conjunction with the drawings, with the single figure, FIG. 1, being a flowchart showing a method according to the invention.

### DETAILED DESCRIPTION OF THE PREFERRED EMBODIMENTS

FIG. 1 is a flowchart of a method according to the invention.

The molded part made from a polymer to be dyed is preferably produced in a photopolymerization process.

First, the molded part made from a polymer that has been produced in a 3D printing process is placed in a dye solution in order to dye the molded part (step FS). After dyeing, the molded part is removed from the dye solution and cleaned. “Remove from the dye solution” means that the molded part is separated from the dye solution, for example by draining the dye solution from a container or removing the molded part from the container containing the dye solution. Then, the molded part is post-treated in a first post-treatment step NBS1 in order to fix the dye on the surface of the molded part, as a result of which any possible migration of the dye is significantly reduced. The molded part is then cleaned again and then supplied to a second post-treatment step NBS2, in which the dye is fixed even further on the surface of the molded part and thus any possible migration of the dye is reduced even further.

The two cleaning steps between the dyeing step FS and the first post-treatment step NBS1 and between the first post-treatment step NBS1 and the second post-treatment step NBS2 are optional. The molded part is cleaned with water, preferably with deionized water.

The second post-treatment step NBS2 is also optional.

### Dyeing Step

Metal complex dyes, acid dyes, reactive dyes, azo dyes, dispersion dyes, or combinations thereof are used for the dyeing in the dyeing step. It has been found that acid and metal complex dyes have a low tendency to migrate due to their molecular size, and this has a positive effect on the migration resistance of the dyed molded parts. However, due to the low tendency to migrate, penetration of the dye into the surface of the molded part is made difficult or even prevented, particularly at those points on the surface of the molded part where there is unreacted or only partially reacted polymer or resin. Dyeing with metal complex or acid dyes dissolved in water (without further additives and with short dyeing times) therefore leads to an irregularly dyed surface of the molded parts. Such a simple dyeing process is therefore suitable for use in quality checks of molded parts made from a polymer that have been produced in a 3D printing process, since it exposes production errors, in particular material on the surface of the molded part that has not reacted completely due to the dye not being absorbed or being absorbed to a reduced extent.

A high-quality, homogeneously dyed surface of a molded part made from a polymer that has been produced in a 3D printing process cannot be achieved with this method, however.

Therefore, for the dyeing in the dyeing step, a dye solution is used which comprises, based on the total composition of the dye solution,
0.0001 to 10 wt. %, preferably 0.0001 to 1 wt. %, of a dye,
optionally an acid or an acid buffer, and
proportions of water, preferably deionized water, to make up to 100 wt. %.

Reactive dyes, azo dyes, dispersion dyes and mixtures thereof can be used as dyes. It is particularly advantageous for metal complex dyes, acid dyes and mixtures thereof to be used.

Acetic acid or an acetic acid/acetate buffer, for example, can be used as the acid or acid buffer. An alternative acid is, for example, formic acid. Alternative buffers are, for example, buffers consisting of citric acid/NaCl/NaOH, buffers consisting of citric acid/sodium citronate, buffers consisting of potassium hydrogen phthalate/NaOH, or a buffer consisting of formic acid/sodium formate.

By using the dye solution, a low level of migration of the dye is achieved. In addition, it has surprisingly been found that, by using the acid or the acid buffer in the dye solution, a homogenously dyed surface of a molded part made from a polymer that has been produced in a 3D printing process can be guaranteed and also the penetration of the migration-resistant dye into the surface of the molded part is facilitated such that, after the dyeing step, the material on the surface of the molded part is dyed to a certain penetration depth.

Experiments have shown that the amount of acid or acid buffer in the dye solution should be selected such that the pH of the dye solution is between 2.5 and 7, preferably between 3.5 and 6, particularly preferably between 4 and 5.

The molded part to be dyed is placed in the dye solution, which solution is at approximately room temperature (15° C. to 25° C.). Then, the dye solution together with the molded part contained therein is heated to a temperature between 30° C. and 150° C., preferably between 60° C. and 120° C., for between approximately 5 minutes and 500 minutes, preferably for between approximately 10 minutes and 200 minutes.

Alternatively, the molded part can also be placed in the dye solution heated to a temperature between 30° C. and 150° C., preferably between 60° C. and 120° C. However, it has been found that the molded part is exposed to considerable thermal stress due to the temperature difference between the molded part and the dye solution, which stress can change the material properties of the molded part and can lead, for example, to thermal distortion or to a change in the geometry of the molded part (or loss of mechanical properties, e.g., restoring force), which may not be desired.

It is advantageous for the dye solution together with the molded part contained therein to be heated to the temperature between 30° C. and 150° C., preferably between 60° C. and 120° C., at a heating rate of below 5° C./min. As a result, the thermal stress to which the molded part is exposed during heating can be reduced to a minimum.

Adding a quaternary ammonium salt to the dye solution in a ratio to the dye of between 10:1 and 1:10, preferably in a ratio of between 5:1 and 1:5, particularly preferably in a ratio of between 2:1 and 1:2 (mass ratio of quaternary ammonium salt to dye) can result in an improved dyeing result.

By adding the quaternary ammonium salt, ammonium salt-dye compounds are temporarily formed in the dye solution. These compounds exhibit accelerated diffusion in the molded part. At the same time, as weakly cationic surfactants, they increase the usability of the molded parts with dye solution. It has been found that typical problems of dyeing 3D printed molded parts in the immersion bath process can thereby be avoided or at least considerably reduced.

Firstly, the depth of penetration of the dye into the material of the molded part or the speed at which the dye penetrates the material of the molded part increases. This results in a greater penetration depth of the dye with a shorter dyeing time, which in turn increases the color fastness of the dyed molded part.

In addition, if the dyeing time and dye concentration remain the same, the tone of color achieved is more intense (darker). In order to achieve, with the same dyeing time, the same tone of color using a dye solution containing a quaternary ammonium salt as a dye solution not containing a quaternary ammonium salt, the concentration of the dye can be reduced by adding quaternary ammonium salts. A reduced dye concentration in the dye solution also has a positive effect in terms of dye pollution in the wastewater produced during dyeing. By adding quaternary ammonium salts to the dye solution, the dye concentration in the wastewater can be reduced. This is particularly advantageous when using metal complex dyes, since these have metal centers based on chromium, iron, cobalt or nickel which are particularly hazardous to wastewater.

Furthermore, it has been found that the problem of inhomogeneous dyeing can be avoided or reduced by adding quaternary ammonium salts to the dye solution, even if the dyeing time is short. In particular, regions having monomer residues or only partially reacted material on the surface can be dyed almost identically to the rest of the component by adding quaternary ammonium salts, even with short dyeing times.

Tetrabutylammonium bromide, for example, can be used as a quaternary ammonium salt. Alternative quaternary ammonium salts are, for example, tetrapropylammonium hydroxide, tetraethylammonium chloride, tetraethylammonium iodide, tetrabutylammonium hydroxide, tetrabutylammonium chloride, or tetrabutylammonium iodide.

Typical dyeing times for a dye solution not containing a quaternary ammonium salt are between approximately 30 minutes and 500 minutes. If there are no monomer residues or no only partially reacted material on the surface of the molded part, the dyeing time for a dye solution not containing a quaternary ammonium salt can also be between 5 minutes and 500 minutes. It has been found that a dyeing time of more than 500 minutes does not lead to any improvement in the dyeing quality.

Typical dyeing times for a dye solution containing a quaternary ammonium salt are between approximately 5 minutes and 200 minutes, but can also be between approximately 5 minutes and 500 minutes.

Experiments have shown that depths of penetration of the dye into the surface of the molded part of up to 100 μm or more can be achieved. This means that the dye penetrates the molded part. This is advantageous in that, even with portions of the surface of the molded part that have been exposed to high amounts of mechanical stress, the original color of the material (with which the molded part was printed) of the molded part is not exposed (or is at least only exposed very late). This is because, in order for the original color to be exposed, the dyed portion of the molded part, which in many cases is very flexible and therefore difficult to remove, would have to be completely removed. In contrast, the mere application of paint to the surface of the molded part is much more susceptible to mechanical stress, since the paint can flake off at the boundary layer between the paint and the component.

Ammonium or alkali salts, for example trisodium phosphate or sodium sulfate, can be added, where necessary, to the dye solution as adjusters for dyes and/or solubilizers and/or leveling agents and/or defoamers and/or solvents.

Monohydric and polyhydric alcohols, ethers, amides, acetates and nitriles, e.g., benzyl alcohol, ethylene glycol, propylene glycol, di- and triethylene glycol, ethylene glycol monomethyl ether, diethylene glycol monoethyl ether acetate, dipropylene glycol, glycerol, glycerol-1,3-diethyl ether, formamide, N,N-dimethylacetamide, N,N-dimethyl methoxy acetamide, or N,N,N′,N′-tetramethylurea and mixtures thereof can be used as solubilizers.

Ethoxylates and esters of, for example, fatty acids, alcohols or alkylamines have been found to be suitable as leveling agents.

Ethoxylates, for example of alcohols or esters, for example phosphoric acid isonyl esters, polysiloxanes, mineral oils and mixtures thereof are suitable as defoamers.

Before the molded part is removed from the dye solution, it is advantageous to cool the dye solution to a temperature between 20° C. and 75° C. In order to also prevent an undesired change in the material properties of the molded part, it is advantageous to carry out the cooling at a cooling rate of below 5° C./min. The removal of the molded part can be both an active removal of the molded part from the dye solution and a draining of the dye solution from the dye container, with the molded part remaining in the empty dye container.

At the end of the dyeing process, a cleaning step can optionally be carried out. The dyed molded part removed from the dye solution is rinsed with water, or particularly preferably with deionized water. The method according to embodiments of the invention is particularly advantageous in that this cleaning step is not absolutely necessary and completely dispenses with the use of reactive chemicals. According to embodiments of the invention, there is no need for reductive cleaning of the molded parts in an alkaline medium, which is common in other dyeing and fixing processes.

This is advantageous in that the molded parts are only exposed to one medium (acidic to neutral) during dyeing, which significantly reduces the chemical stress on the surface of the molded parts. This is because, as with rapid temperature changes, a change in the pH from acidic to basic can also have a negative effect on the molded part.

In addition, reductive cleaning can result in partial discoloration of the molded part and thus an undesired change in the tone of color. Particularly in the case of dyes in which the tone of color is determined by an azo group, reductive cleaning can lead to discoloration, since the azo bridge is split by the reducing agent.

Moreover, reductive cleaning takes a very long time. Experiments have shown that reductive cleaning can take up to an hour or more, whereas cleaning, i.e, rinsing, with water can be carried out within a few minutes.

### First Post-Treatment Step

In the first post-treatment step, the dye is fixed on the surface of the molded part or in the material on the surface of the molded part. In other words, the mobility of the dye in the material of the molded part is reduced to such an extent that the dye is prevented from migrating to other materials that come into contact with the molded part dyed according to this method.

For this purpose, the molded part dyed in the dyeing step and optionally cleaned after dyeing is placed in a first fixing solution for between 1 minute and 500 minutes, preferably between 5 minutes and 500 minutes, particularly preferably between 10 minutes and 60 minutes, said first fixing solution comprising
0.0001 to 10 wt. %, preferably 0.0001 to 0.5 wt. %, of a polyphenol, an acrylic-based syntan compound, or a synthetic condensation product of aromatic compounds, in particular phenols or naphthalenesulfonic acid, with formaldehyde or urea, and
proportions of water, preferably deionized water, to make up to 100 wt. %.

In the process, between the dye and the polyphenol or the acrylic-based syntan compound or the condensation product, complexes are formed which, due to their size, reduce the mobility of the dye such that the dye is prevented from migrating. This makes it possible to dye a molded part made from a polymer produced in a 3D printing process in which the dye is migration-resistant.

Tannic acid, corilagin, glucogallin, pedunculagin and other polyphenol derivatives, aromatic sulfonic acid condensation products, acrylic acid derivative copolymers, aromatic macromolecule derivatives, aliphatic amine derivatives, oxysulfonate condensation products, polyethylene amine derivatives, aryl sulfonate formaldehyde condensation products and macromolecular aromatic sulfonic acids have been found to be suitable fixing agents.

The first fixing solution is heated to a temperature between 30° C. and 150° C., preferably between 60° C. and 90° C., in order to achieve an optimum effect in terms of dye fixation.

It can be advantageous for the first fixing solution to additionally have an acid or an acid buffer, wherein the amount of acid or acid buffer is selected such that the pH of the first fixing solution is between 3 and 7, preferably between 4 and 5.5. This ensures a good level of stability of the phenols, the acrylic-based syntan compound or the condensation product, as well as a good level of solubility thereof.

In order not to also expose the molded part to thermal stress during the first post-treatment step, it is advantageous to heat the first fixing solution together with the dyed molded part to the temperature between 30° C. and 150° C., preferably between 60° C. and 90° C., at a heating rate of below 5° C./min.

Before the molded part is removed from the first fixing solution, it is advantageous to cool the first fixing solution to a temperature between 20° C. and 75° C. In order to also prevent an undesired change in the material properties of the molded part, it is advantageous to carry out the cooling at a cooling rate of below 5° C./min.

With the dyeing step and the subsequent first post-treatment step, a dyed molded part made from a polymer is provided which has an extremely homogeneously dyed surface and is characterized by high migration resistance of the dye. Due to the achieved depth of penetration of the dye into the surface of the molded part, the color is prevented from flaking off and therefore the color of the molded part is retained even when said part is subject to mechanical stress.

Surprisingly, it has been found that the method not only achieves particularly good fixation of the dyes, but also matt surfaces can be produced, which make the molded part look to be of a particularly high quality. The method is therefore also suitable for producing dyed and matt surfaces of molded parts that are printed in a 3D printing process, in particular in a photopolymerization process, more particularly in a bath-based photopolymerization process.

### Second Post-Treatment Step

After the first post-treatment step and, where applicable, after cleaning the molded part, a second post-treatment step can optionally be carried out in order to further improve the fixation of the dye on the surface or in the material of the surface and to reinforce the matting effect.

In the second post-treatment step, the molded part is placed in a second fixing solution for between 5 minutes and 500 minutes, preferably between 10 minutes and 60 minutes. The second fixing solution together with the molded part contained therein is heated to a temperature between 30° C. and 150° C., preferably between 60° C. and 90° C.

The second fixing solution has
0.0001 to 10 wt. %, preferably 0.0001 to 0.5 wt. %, of a salt of a trivalent or tetravalent cation, and
proportions of water, particularly preferably deionized water, to make up to 100 wt. %.

The salt of a trivalent or tetravalent cation reduces the mobility of the dye even further, since a complex is formed which is even more stable and significantly less soluble. Accordingly, the migration resistance of the dye can be increased even further.

Suitable salts of a trivalent or tetravalent cation (antimony, iron, chromium, copper, titanium, zirconium or bismuth) are, for example, antimony acetate, potassium antimonyl tartrate or titanyl sulfate.

In order not to also expose the molded part to thermal stress during the second post-treatment step, it is advantageous to heat the second fixing solution together with the molded part to the temperature between 30° C. and 150° C., preferably between 60° C. and 90° C., at a heating rate of below 5° C./min.

Before the molded part is removed from the second fixing solution, it is advantageous to cool the second fixing solution to a temperature between 20° C. and 75° C.

In order to also prevent an undesired change in the material properties of the molded part, it is advantageous to carry out the cooling at a cooling rate of below 5° C./min.

In one embodiment of the invention, the dyeing step FS and/or the first post-treatment step NBS1 and/or the second post-treatment step NBS2 can be carried out in a pressure-tight container at overpressure or above atmospheric pressure.

This can prevent the dye solution or constituents of the dye solution and/or the first fixing solution or constituents of the first fixing solution and/or the second fixing solution or constituents of the second fixing solution from evaporating, and therefore it is ensured that the molded part is contained fully in the aqueous dye solution or in the aqueous fixing solutions during the dyeing step or during the post-treatment step, respectively.

### EXAMPLE 1

### Dyeing Step

An aqueous dye solution (preferably based on deionized water) is prepared having the following composition:
0.075 wt. % of the dye C.I.Acid Red 131,
0.05 wt. % of tetrabutylammonium bromide (quaternary ammonium salt), and
0.1 wt. % of acetic acid (the pH of the dye solution is approximately 4.25).

The molded part, which has been printed from an elastic polyurethane in a 3D printing process, is placed in the dye solution. The dye solution and the molded part contained therein are then together heated to 75° C. at a heating rate of 2° C./min. The temperature of 75° C. is maintained for 20 minutes.

By adding the quaternary ammonium salt, homogeneous dyeing is achieved after just 5 minutes. In order to achieve greater depths of penetration of the dye into the material of the surface of the molded part, the dyeing is carried out for 20 minutes.

The dye solution together with the molded part contained therein is then cooled at a cooling rate of 2° C./min. When the temperature reaches approximately 50° C., the molded part is removed from the dye solution.

The molded part is then removed from the dye solution and cleaned with water (preferably deionized water).

### First Post-Treatment Step

An aqueous first fixing solution (preferably based on deionized water) is prepared having the following composition:
0.125 wt. % of tannic acid (as polyphenol), and
0.1 wt. % of formic acid (the pH of the fixing solution is approximately 5).

The first fixing solution is heated to approximately 40° C. in order for the tannic acid to dissolve quickly. The dyed molded part is then placed in the first fixing solution and the first fixing solution is heated further to a temperature of 80° C. at a heating rate of 3° C./min. This temperature is maintained for 15 minutes.

Then, the first fixing solution together with the molded part contained therein is cooled to approximately 40° C. at a cooling rate of 1° C./min.

The molded part is then removed from the first fixing solution and cleaned with water (preferably deionized water).

In an alternative variant, a concentrate of the first fixing solution is prepared having the following composition:
1.25 g of tannic acid (as polyphenol),
1 ml of formic acid, and
approx. 50 ml of water (preferably deionized water).

This concentrate is then heated to approximately 40° C.

The molded part is placed in approximately 950 ml of water (preferably deionized water), the water together with the molded part preferably being heated to approximately 40° C.

The heated concentrate is then added to the water together with the molded part such that a first fixing solution containing 0.125 wt. % of tannic acid and 0.1 wt. % of formic acid is formed. The pH of the fixing solution is approximately 5.

The first fixing solution together with the molded part arranged therein is then heated further to a temperature of 80° C. at a heating rate of 3° C./min. This temperature is maintained for 15 minutes.

Then, the first fixing solution together with the molded part contained therein is cooled to approximately 40° C. at a cooling rate of 1° C./min.

The molded part is then removed from the first fixing solution and cleaned with water (preferably deionized water).

### EXAMPLE 2

### Dyeing Step

An aqueous dye solution (preferably based on deionized water) is prepared having the following composition:
0.1 wt. % of the dye C.I. Acid Black 172, and
0.1 wt. % of acetic acid/acetate buffer (a pH of 4.5 is set).

The molded part, which has been printed from a flexible methacrylate-based polymer in a 3D printing process, is placed in the dye solution. The dye solution and the molded part arranged therein are then heated to 75° C. at a heating rate of 2° C./min. The temperature of 75° C. is maintained for 200 minutes. A quaternary ammonium salt can be added to the dye solution, which can reduce the dyeing time.

The dye solution and the molded part arranged therein are then cooled to approximately 50° C. at a cooling rate of 2° C./min.

The molded part is then removed from the dye solution and cleaned with water (preferably deionized water).

### First Post-Treatment Step

An aqueous first fixing solution (preferably based on deionized water) containing 0.2 wt. % of EPIZOTAN FR-8800 (trade name of the manufacturer FA-KS Chemicals) is prepared.

The first fixing solution is then heated to a temperature of 35° C.

The dyed molded part is placed in the first fixing solution and the first fixing solution is heated together with the molded part contained therein to a temperature of 70° C. at a heating rate of 3° C./min. The temperature of 70° C. is maintained for 30 minutes.

The first fixing solution together with the molded part contained therein is then cooled to approximately 40° C. at a cooling rate of 1° C./min.

The molded part is then removed from the first fixing solution and cleaned with water (preferably deionized water).

The first post-treatment step from example 1 can also be used as the first post-treatment step in example 2. Likewise, the first post-treatment step from example 2 can also be used as the first post-treatment step in example 1.

In the above examples 1 and 2, a second post-treatment step can be carried out after the first post-treatment step.

For this purpose, an aqueous second fixing solution (preferably based on deionized water) containing 0.125 wt. % of potassium antimonyl tartrate is prepared.

The second fixing solution is then heated to approximately 40° C. The molded part is then placed in the second fixing solution and the second fixing solution together with the molded part arranged therein is heated to a temperature of 80° C. at a heating rate of 3° C./min. The temperature of 80° C. is maintained for 20 minutes.

The second fixing solution together with the molded part contained therein is then cooled to approximately 40° C. at a cooling rate of 1° C./min.

The molded part is then removed from the second fixing solution and cleaned, for example with water.

Overview table of examples 1 and 2

| | Example 1 | | Example 2 | |
|---|---|---|---|---|
| Material of the | elastic polymer based | | flexible polymer based | |
| printed molded | on urethane | | on methacrylate | |
| part | | | | |
| Dye solution | 0.075 wt. % of the dye | | 0.1 wt. % of the dye | |
| (aqueous) | C.I. Acid Red 131, | | C.I. Acid Black 172, | |
| | 0.05 wt. % of | | 0.1 wt. % of acetic | |
| | tetrabutylammonium | | acid/acetate buffer | |
| | bromide, and 0.1 wt. % | | | |
| | of acetic acid | | | |
| Dyeing time | 20 | minutes | 200 | minutes |
| Dyeing temperature | 75° | C. | 75° | C. |
| First fixing solution | 0.125 wt. % of tannic | | 0.2 wt. % of | |
| | acid, and 0.1 wt. % | | EPIZOTAN | |
| | of formic acid | | FR-8800 | |
| Fixation time | 15 | minutes | 30 | minutes |
| Fixation temperature | 80° | C. | 70° | C. |
| Achieved surface of | matt-looking | | matt-looking | |
| the molded part | red surface; | | black surface; | |
| | homogeneous | | homogeneous | |
| | dyeing; no dye | | dyeing; no dye | |
| | migration; | | migration; | |
| Depth of penetration | 50 | μm | 80 | μm |
| of the dye into the | | | | |
| material of the | | | | |
| molded part | | | | |

### EXAMPLE 3

The experiment according to example 1 was repeated. In contrast to example 1, however, the dyeing time was increased to approximately 60 minutes. The result was a molded part with a matt-looking homogeneous red surface. No dye migration was detectable. However, a depth of penetration of the dye into the material of the molded part of approximately 110 μm was achieved.

### EXAMPLE 4

### Dyeing Step

An aqueous dye solution (preferably based on deionized water) is prepared having the following composition:
0.25 wt. % of the dye C.I.Disperse Blue 354,
0.5 wt. % of the dyeing auxiliary agent benzyl alcohol, and
0.1 wt. % of acetic acid/acetate buffer (a pH of 4.5 is set).

The molded part, which has been printed from a polypropylene in a 3D printing process, is placed in the dye solution. The dye solution and the molded part arranged therein are then heated to 100° C. at a heating rate of 2° C./min. The temperature of 100° C. is maintained for 30 minutes.

The dye solution and the molded part arranged therein are then cooled to approximately 50° C. at a cooling rate of 2° C./min.

The molded part is then removed from the dye solution and cleaned with water (preferably deionized water).

### First Post-Treatment Step

An aqueous fixing solution (preferably based on deionized water) containing 0.5 wt. % of the phenol-based syntan compound MIDA FL (trade name of the manufacturer Bi-Qem) is prepared.

The first fixing solution is then heated to a temperature of 25° C.

The dyed molded part is placed in the first fixing solution and the first fixing solution is heated together with the molded part contained therein to a temperature of 55° C. at a heating rate of 3° C./min. The temperature of 55° C. is maintained for 45 minutes.

The first fixing solution together with the molded part contained therein is then cooled to approximately 40° C. at a cooling rate of 1° C./min.

The molded part is then removed from the first fixing solution and cleaned with water (preferably deionized water).

What is claimed is:

1. A method for dyeing a molded part produced in a 3D printing process with a polymer, wherein the method comprises:
a dyeing step (FS) for dyeing the surface of the molded part with a dye, and
a first post-treatment step (NBS1) for fixing the dye which has penetrated the surface of the molded part, wherein the first post-treatment step is carried out after the dyeing step,
wherein, in the dyeing step,
the molded part is placed in a dye solution, wherein the dye solution comprises
a dye, and
water, preferably deionized water,
wherein the dye is introduced into the material of the surface of the molded part, and
the dye solution is heated, and,
in the first post-treatment step,
the molded part dyed in the dyeing step is placed in a first fixing solution, as a result of which the dye introduced into the material of the surface of the molded part is fixed, wherein the first fixing solution comprises
a polyphenol, an acrylic-based syntan compound, or a synthetic condensation product of aromatic compounds, in particular phenols or naphthalenesulfonic acid, with formaldehyde or urea, and
water, preferably deionized water, and
the first fixing solution is heated.

2. The method of claim 1, wherein
the dye solution comprises:
0.0001 to 10 wt. %, preferably 0.0001 to 1 wt. %, of the dye and
proportions of water to make up to 100 wt. %, and/or
the first fixing solution comprises:
0.0001 to 10 wt. %, preferably 0.0001 to 0.5 wt. % of the polyphenol, the acrylic-based syntan compound, or the synthetic condensation product, and
proportions of water to make up to 100 wt. %.

3. The method of claim 1, wherein the dye solution has an acid or an acid buffer, wherein the amount of acid or acid buffer is selected such that the pH of the dye solution is between 2.5 and 7.

4. The method of claim 1, wherein
the dye solution is heated to a temperature between 30° C. and 150° C., and/or
the first fixing solution is heated to a temperature between 30° C. and 150° C.

5. The method of claim 1, wherein the dye solution additionally has a quaternary ammonium salt in a ratio to the dye of between 10:1 and 1:10 (mass ratio of quaternary ammonium salt to dye).

6. The method of claim 1, wherein the first fixing solution additionally has an acid or an acid buffer, wherein the amount of acid or acid buffer is selected such that the pH of the first fixing solution is between 3 and 7.

7. The method of claim 1, wherein the dye solution is heated after the molded part has been placed in the dye solution, wherein the dye solution is heated at a heating rate of below 5° C./min.

8. The method of claim 1, wherein the first fixing solution is heated after the dyed molded part has been placed in the first fixing solution, wherein the first fixing solution is heated at a heating rate of below 5° C./min.

9. The method of claim 1, wherein the dye solution is cooled to a temperature between 20° C. and 75° C. before the molded part is removed from the dye solution, wherein the cooling takes place at a cooling rate of below 5° C./min.

10. The method of claim 1, wherein the first fixing solution is cooled to a temperature between 20° C. and 75° C. before the molded part is removed from the first fixing solution, wherein the cooling takes place at a cooling rate of below 5° C./min.

11. The method of claim 1, wherein the method comprises a second post-treatment step (NBS2) for further fixing the applied dye to the molded part, wherein the second post-treatment step is carried out after the first post-treatment step, wherein, in the second post-treatment step,
the molded part is placed in a second fixing solution, wherein the second fixing solution comprises:
a salt of a trivalent or tetravalent cation and
water, particularly preferably deionized water, and
the second fixing solution is heated.

12. The method of claim 11, wherein the second fixing solution comprises:
0.0001 to 10 wt. %, preferably 0.0001 to 0.5 wt. %, of the salt and
proportions of water to make up to 100 wt. %.

13. The method of claim 11, wherein the second fixing solution is heated to a temperature between 30° C. and 150° C.

14. The method of claim 11, wherein the second fixing solution is heated after the molded part has been placed in the second fixing solution, wherein the second fixing solution is heated at a heating rate of below 5° C./min.

15. The method of claim 1, wherein the second fixing solution is cooled to a temperature between 20° C. and 75° C. before the molded part is removed from the second fixing solution, wherein the cooling takes place at a cooling rate of below 5° C./min.

16. The method of claim 1, wherein
the first fixing solution is heated to a temperature between 30° C. and 45° C. before the molded part is placed in the first fixing solution, or
a concentrate of the fixing solution is heated to a temperature between 30° C. and 45° C. and the heated concentrate is mixed with water to obtain the fixing solution, wherein
the molded part is placed in the water before the heated concentrate is mixed with the water, wherein the water is preferably likewise heated to a temperature between 30° C. and 45° C. before the heated concentrate is mixed with the water, or
the molded part is placed in the fixing solution after the heated concentrate has been mixed with the water.

17. The method of claim 1, wherein the dye solution additionally comprises:
ammonium or alkali salts as adjusters for dyes, and/or
a solubilizer, and/or
a leveling agent,
a defoamer, and/or
a solvent.

18. The method of claim 1, wherein the molded part is cleaned
between the dyeing step and the first post-treatment step, and/or
between the first post-treatment step and the second post-treatment step preferably with water, particularly preferably with deionized water.

19. The method of claim 1, wherein
the molded part is placed in the dye solution for a period of between 5 minutes and 500 minutes, and/or
the molded part is placed in the first fixing solution for between 5 minutes and 500 minutes.

20. The method of claim 11, wherein the molded part is placed in the second fixing solution for between 5 minutes and 500 minutes.

21. The method of claim 1, wherein the dye is selected from the group comprising metal complex dyes, acid dyes, reactive dyes, azo dyes, dispersion dyes, and mixtures thereof.

22. The method of claim 1, wherein the 3D printing process is a photopolymerization process.

23. The method of claim 1, wherein the dyeing step and/or the first post-treatment step and/or the second post-treatment step are carried out in a pressure-tight container at overpressure.

24. The method of claim 1, wherein the polymer is a polymer having a Shore hardness of 10 Shore A to 85 Shore D, preferably a flexible/elastic polymer having a Shore hardness of 10 Shore A to 85 Shore D, particularly preferably a flexible/elastic polymer based on acrylate and/or urethane.
